(19) United States
(12) Patent Application Publication
(10) Pub. No.: US 2026/0369906 A1
(43) Pub. Date: Nov. 19, 2026

(54) CONNECTOR HAVING FIRST MOUNTING PORTION AND SECOND MOUNTING PORTION LOCATED ON OPPOSITE SIDES OF MOUNTING BASE

(71) Applicant: SPEED TECH CORPORATION, Taoyuan City (TW)

(72) Inventors: Juehao YU, Taoyuan City (TW); Shengchin HSU, Taoyuan City (TW)

(73) Assignee: SPEED TECH CORPORATION, Taoyuan City (TW)

(21) Appl. No.: 19/250,976

(22) Filed: Jun. 26, 2025

(30) Foreign Application Priority Data
May 16, 2025 (CN) 202510632085.3

(51) Int. Cl. H01R 11/01; H01R 4/02

(52) U.S. Cl. CPC H01R 11/01; H01R 4/023; H01R 4/027

(57) ABSTRACT

A connector includes an insulating body, a mounting base, a conductive terminal, a conductive shell, and a cable. The insulating body includes a main body portion. The conductive terminal includes a contact portion disposed in the main body portion and a first mounting portion disposed on the mounting base. The contact portion is configured to contact a mating conductive terminal. The conductive shell is at least partially sleeved on the insulating body. The conductive shell includes a second mounting portion disposed on the mounting base. The cable includes a first polarity wire and a second polarity wire. The first polarity wire is electrically connected to the first mounting portion. The second polarity wire is electrically connected to the second mounting portion. The first mounting portion and the second mounting portion are located on opposite sides of the mounting base, respectively.

### CROSS-REFERENCE TO RELATED APPLICATION

This patent application claims priority of a Chinese Patent Application No. 202510632085.3, filed on May 16, 2025 and titled “CABLE CONNECTOR”, the entire content of which is incorporated herein by reference.

### TECHNICAL FIELD

The present disclosure relates to a connector, which belongs to the technical field of power connectors.

### BACKGROUND

A connector in the related art includes an insulating body, a conductive terminal, a conductive shell and a cable. The cable includes a power wire. The power wire is electrically connected to the conductive terminal.

The cable may further include a grounding wire. The grounding wire is electrically connected to the conductive shell. Generally, the grounding wire extends longer than the power wire, thereby facilitating soldering or welding of the grounding wire to the conductive shell.

Alternatively, the cable does not include a grounding wire, but is provided with a grounding layer. At this time, the conductive shell is further provided with a fastening portion. The fastening portion is fixed on the grounding layer by riveting.

It is understandable to those skilled in the art that the grounding connection method of the connectors in the related art requires more processing areas, resulting in a larger overall size.

### SUMMARY

The present disclosure adopts the following technical solution: a connector including: an insulating body including a main body portion; a mounting base connected to the insulating body; a conductive terminal disposed in the insulating body, the conductive terminal including a contact portion disposed in the main body portion and a first mounting portion disposed on the mounting base, the contact portion being configured to contact a mating conductive terminal; a conductive shell at least partially enclosing the insulating body, the conductive shell including a second mounting portion disposed on the mounting base; and a cable including a first polarity wire and a second polarity wire, the first polarity wire being electrically connected to the first mounting portion, and the second polarity wire being electrically connected to the second mounting portion; wherein the first mounting portion and the second mounting portion are located on opposite sides of the mounting base.

The present disclosure also adopts the following technical solution: a connector including: an insulating body including a main body portion; a mounting base connected to the insulating body; a conductive terminal coupled with the insulating body, the conductive terminal including a contact portion disposed in the main body portion and a first mounting portion attached to the mounting base from a first side; a conductive shell at least partially sleeved on the insulating body, the conductive shell including a second mounting portion attached to the mounting base from a second side, the first side being disposed opposite to the second side; and a cable including a power wire and a grounding wire, the power wire being electrically connected to the first mounting portion, and the grounding wire being electrically connected to the second mounting portion; wherein the first mounting portion and the second mounting portion are located on opposite sides of the mounting base.

### BRIEF DESCRIPTION OF DRAWINGS

FIG. 1 is a perspective schematic view of a cable connector in accordance with an embodiment of the present disclosure;

FIG. 2 is a perspective schematic view of FIG. 1 from another angle;

FIG. 3 is a partial perspective exploded view of FIG. 1;

FIG. 4 is a further partial perspective exploded view of FIG. 3;

FIG. 5 is a partial perspective exploded view of FIG. 4 from another angle;

FIG. 6 is a perspective exploded view of a terminal module and a cable;

FIG. 7 is a perspective exploded view of FIG. 6 from another angle;

FIG. 8 is a top view of the terminal module in FIG. 7;

FIG. 9 is a bottom view of FIG. 8;

FIG. 10 is a front view of FIG. 8;

FIG. 11 is a perspective exploded view of the terminal module in FIG. 6;

FIG. 12 is a perspective exploded view of FIG. 11 from another angle;

FIG. 13 is a schematic cross-sectional view taken along line A-A in FIG. 1, in which an over-molding housing is not shown;

FIG. 14 is a partial enlarged view of frame part B in FIG. 13;

FIG. 15 is a perspective schematic view when the terminal module is connected to the cable;

FIG. 16 is a partial perspective exploded view of FIG. 15; and

FIG. 17 is a schematic cross-sectional view taken along line C-C in FIG. 13.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

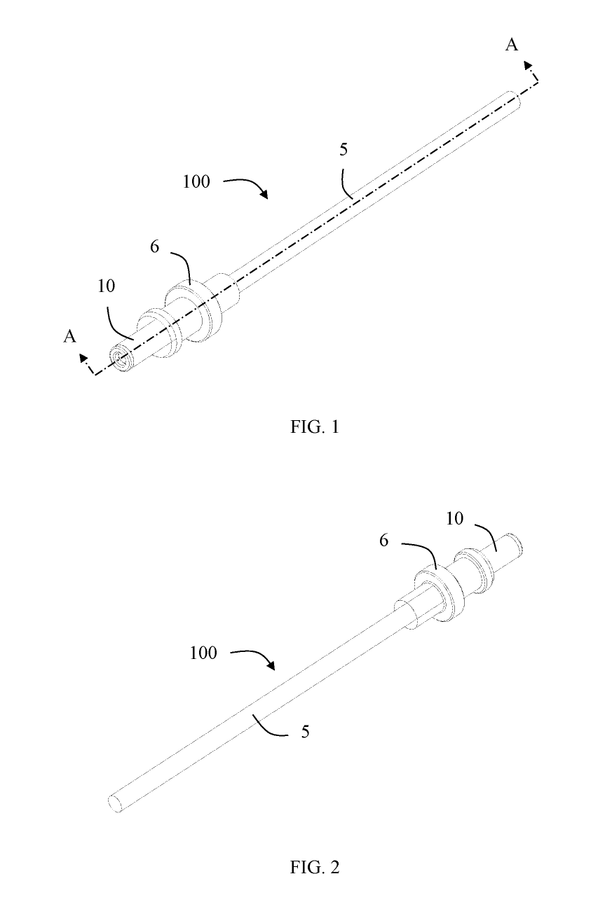

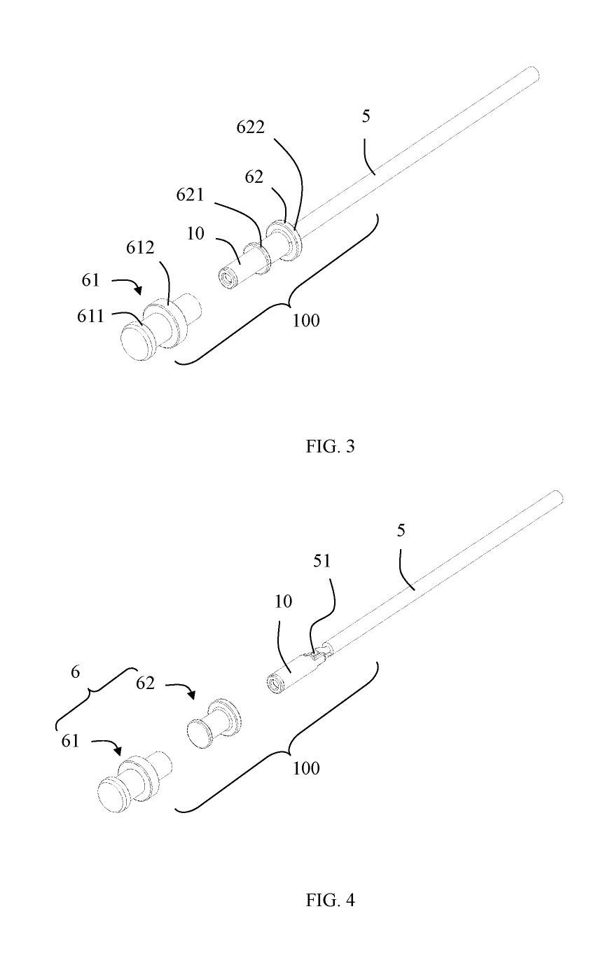

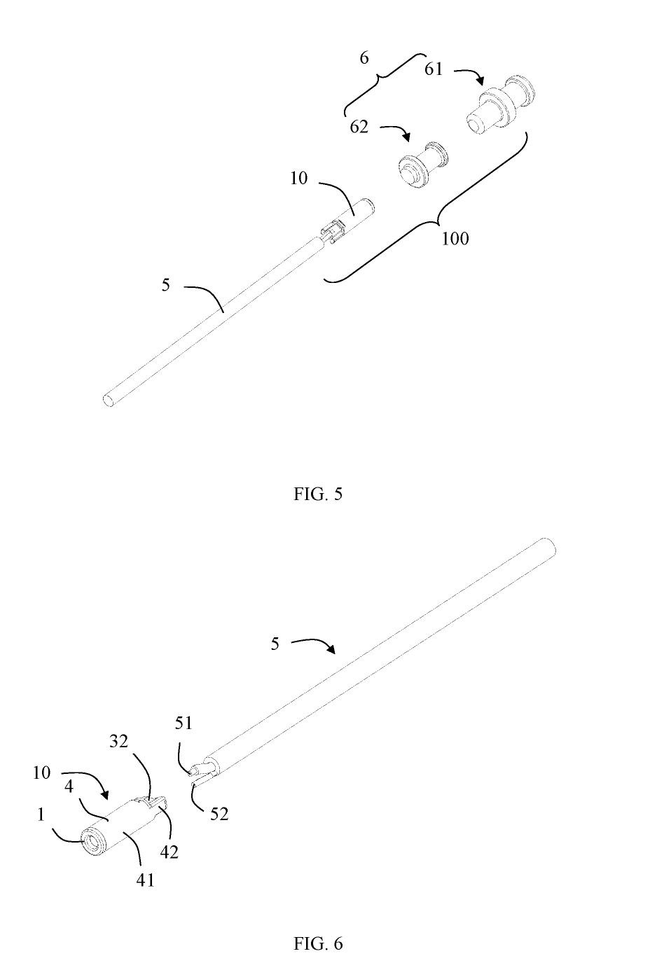

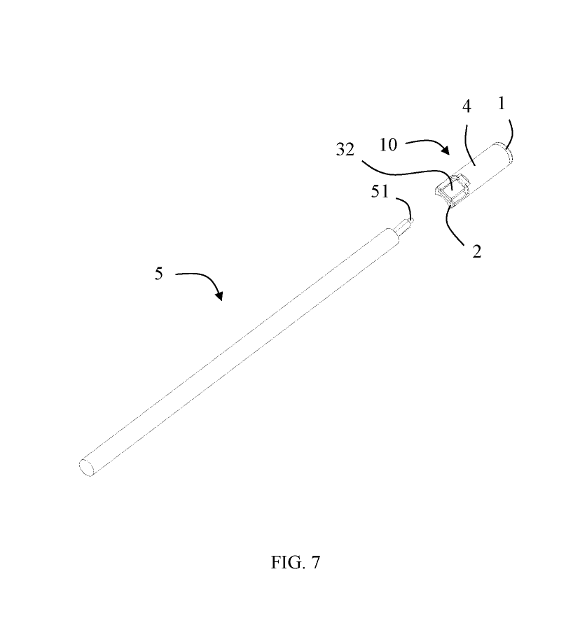

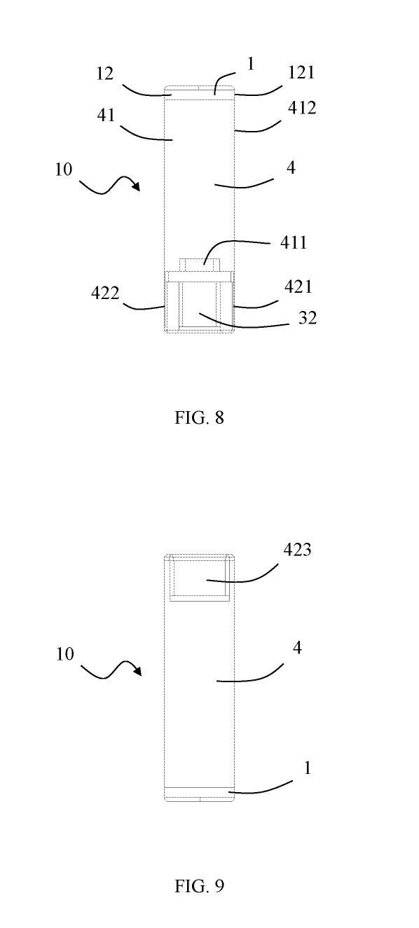

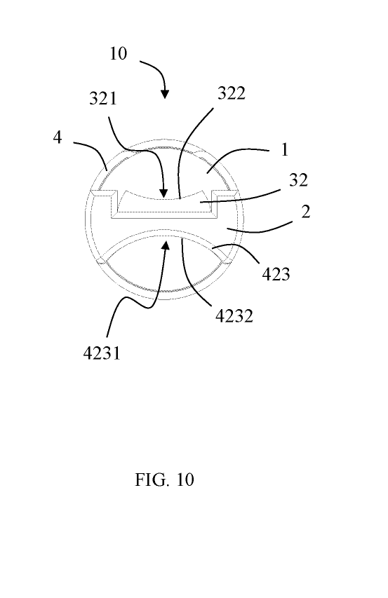

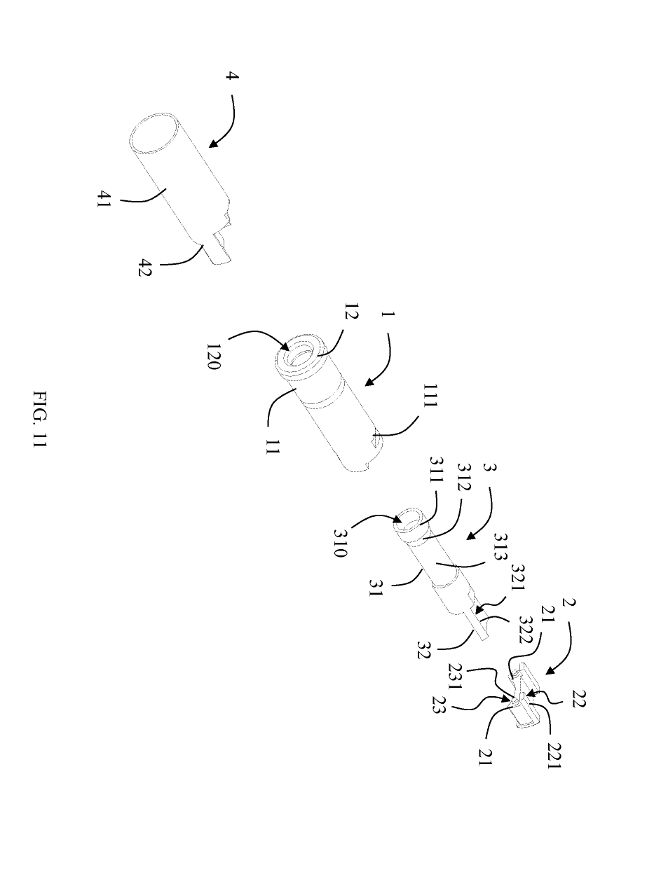

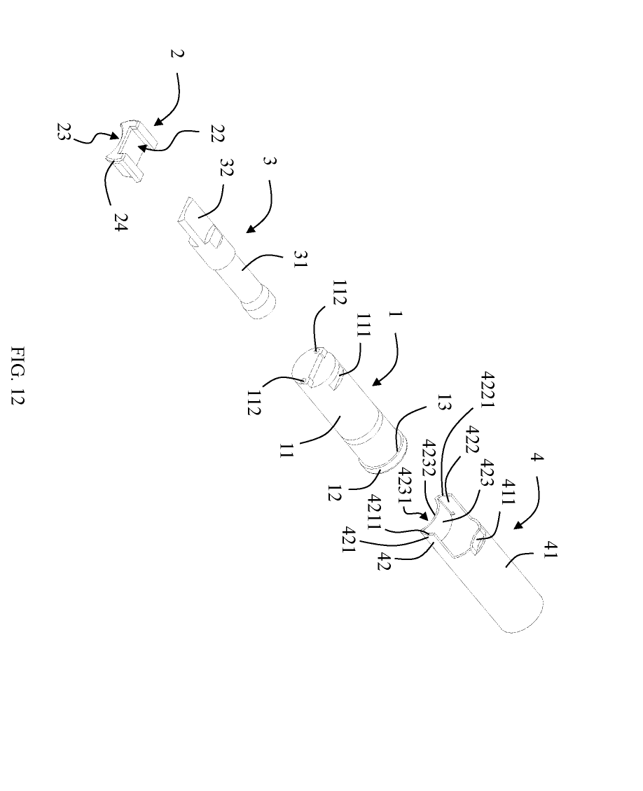

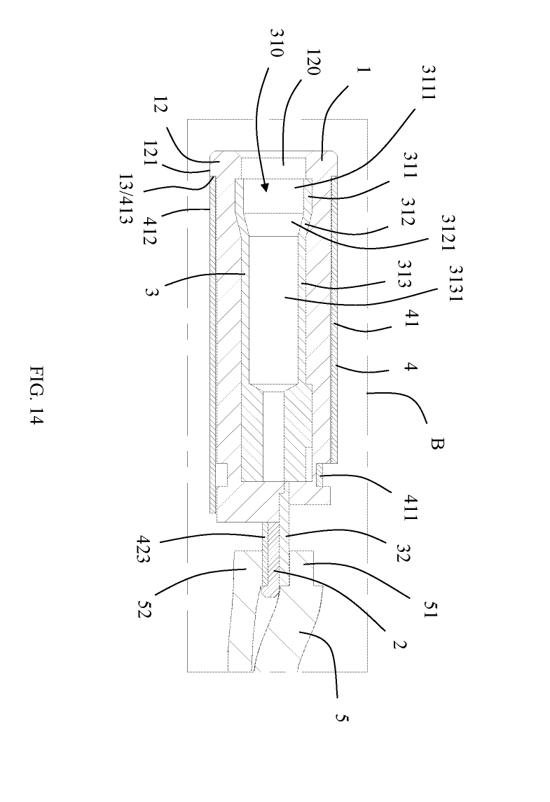

Referring to FIGS. 1-FIG.17, the present disclosure discloses a cable connector 100, including a terminal module 10, a cable 5 connected to the terminal module 10, and an over-molding housing 6 at least partially molded on the terminal module 10 and the cable 5. In the illustrated embodiment of the present disclosure, the cable connector 100 is a power cable connector for transmitting power.

The terminal module 10 includes an insulating body 1, a mounting base 2 connected to the insulating body 1, a conductive terminal 3 disposed in the insulating body 1, and a conductive shell 4 at least partly enclosing the insulating body 1.

In the illustrated embodiment of the present disclosure, the conductive terminal 3 is insert-molded with the insulating body 1 so that the conductive terminal 3 and the insulating body 1 are combined into a whole.

Specifically, referring to FIGS. 11- FIG. 14, in the illustrated embodiment of the present disclosure, the insulating body 1 includes a main body portion 11 and a head portion 12 connected to the main body portion 11. A diameter of the head portion 12 is greater than a diameter of the main body portion 11, such that the insulating body 1 further includes a positioning surface 13 located at a junction of the head portion 12 and the main body portion 11. The conductive terminal 3 is insert-molded in the main body portion 11. The head portion 12 extends forwardly beyond the conductive terminal 3. In the illustrated embodiment of the present disclosure, the main body portion 11 further defines a positioning groove 111 which is located at a rear end thereof and disposed away from the head portion 12.

In the illustrated embodiment of the present disclosure, the mounting base 2 is an insulated mounting base. That is, the mounting base 2 is made of an insulating material. The mounting base 2 is provided separately from the insulating body 1. The mounting base 2 is fixed to the insulating body 1. The mounting base 2 and the insulating body 1 include at least one post 21 and at least one positioning hole 112 that cooperate with each other. In the illustrated embodiment of the present disclosure, the post 21 is provided on the mounting base 2, and the positioning hole 112 is provided on the main body portion 11. The post 21 is inserted into the positioning hole 112. Of course, it is understandable to those skilled in the art that the post 21 and the positioning hole 112 can also be switched in place. That is, the post 21 is provided on the main body portion 11, and the positioning hole 112 is provided on the mounting base 2.

Besides, the mounting base 2 further defines a first mounting groove 22 located on one side thereof and a second mounting groove 23 located opposite to the first mounting groove 22. The first mounting groove 22 and the second mounting groove 23 both extend through the mounting base 2 in an extension direction of the conductive terminal 3. Specifically, in the illustrated embodiment of the present disclosure, the mounting base 2 is provided with a first inner surface 221 located in the first mounting groove 22 and a second inner surface 231 located in the second mounting groove 23. The first inner surface 221 is a flat surface, and the second inner surface 231 is an arc-shaped surface. The mounting base 2 is also provided with a limiting rib 24.

The conductive terminal 3 includes a contact portion 31 disposed in the main body portion 11 and a first mounting portion 32 disposed on the mounting base 2. The contact portion 31 is configured to contact a mating conductive terminal (not shown). In the illustrated embodiment of the present disclosure, the contact portion 31 defines a receiving cavity 310 configured to accommodate the mating conductive terminal. The mating conductive terminal is needle-shaped and is received in the receiving cavity 310. Of course, it is understandable to those skilled in the art that in other embodiments of the present disclosure, the contact portion 31 and the mating conductive terminal can also be switched in place. That is, the contact portion 31 is needle-shaped, and the mating conductive terminal defines a receiving cavity for accommodating the contact portion 31. In the illustrated embodiment of the present disclosure, the head portion 12 defines a through hole 120 that extends through the head portion 12 in an axial direction of the conductive terminal 3, and the through hole 120 is in communication with the receiving cavity 310.

Specifically, referring to FIG. 14, in the illustrated embodiment of the present disclosure, the contact portion 31 includes a first section 311 in a cylindrical shape, a conical portion 312 connected to the first section 311, and a second section 313 connected to the conical portion 312 and in a cylindrical shape. A diameter of the first section 311 is larger than a diameter of the second section 313. The first section 311 defines a first cylindrical hole 3111. The conical portion 312 defines a conical hole 3121. The second section 313 defines a second cylindrical hole 3131. The first cylindrical hole 3111, the conical hole 3121, and the second cylindrical hole 3131 are in communication sequentially. A diameter of the first cylindrical hole 3111 is greater than a diameter of the second cylindrical hole 3131. The first cylindrical hole 3111 facilitates the insertion of the mating conductive terminal. The conical hole 3121 facilitates guiding the mating conductive terminal. The second cylindrical hole 3131 facilitates cooperating with the mating conductive terminal.

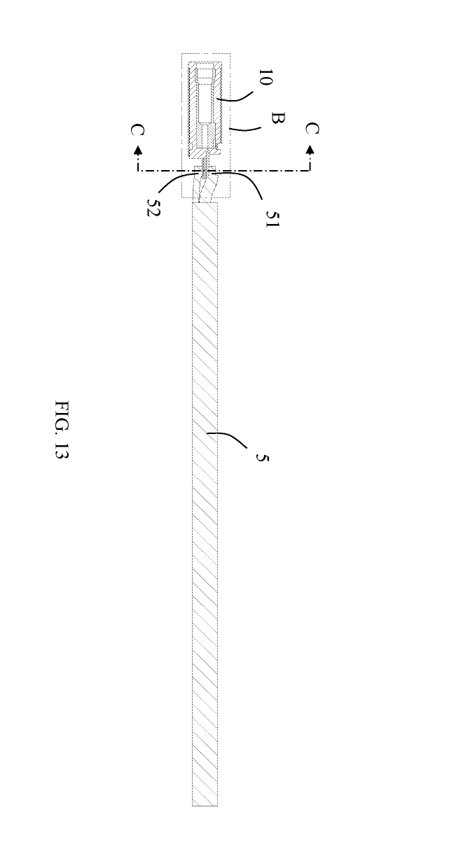

Referring to FIGS. 11 and FIG. 12, the first mounting portion 32 is received in the first mounting groove 22. The first mounting portion 32 defines a first groove 321. Specifically, in the illustrated embodiment of the present disclosure, the first mounting portion 32 is provided with a first arc-shaped mounting surface 322 located in the first mounting groove 22.

The conductive shell 4 is a metal conductive shell, which includes a sleeve portion 41 connected to the main body portion 11 and an extension portion 42 connected to the sleeve portion 41. The extension portion 42 includes a first extension side wall 421, a second extension side wall 422, and a second mounting portion 423 connected between the first extension side wall 421 and the second extension side wall 422. The first extension side wall 421 is provided with a first end face 4211. The second extension side wall 422 is provided with a second end face 4221. The first end face 4211 and the second end face 4221 both abut against an inner side of the limiting rib 24. Besides, the sleeve portion 41 of the conductive shell 4 includes a positioning protrusion 411 that is engaged in the positioning groove 111.

In the illustrated embodiment of the present disclosure, the head portion 12 is provided with a first outer cylindrical surface 121. The sleeve portion 41 is provided with a second outer cylindrical surface 412. The first outer cylindrical surface 121 is flush with the second outer cylindrical surface 412 in order to reduce a diameter of the cable connector 100 as much as possible. The sleeve portion 41 is provided with an end surface 413 that abuts against the positioning surface 13.

The second mounting portion 423 is received in the second mounting groove 23. The second mounting portion 423 defines a second groove 4231. Specifically, in the illustrated embodiment of the present disclosure, the second mounting portion 423 is provided with a second arc-shaped mounting surface 4232 located in the first mounting groove 22. A recessed direction of the first arc-shaped mounting surface 322 is opposite to a recessed direction of the second arc-shaped mounting surface 4232.

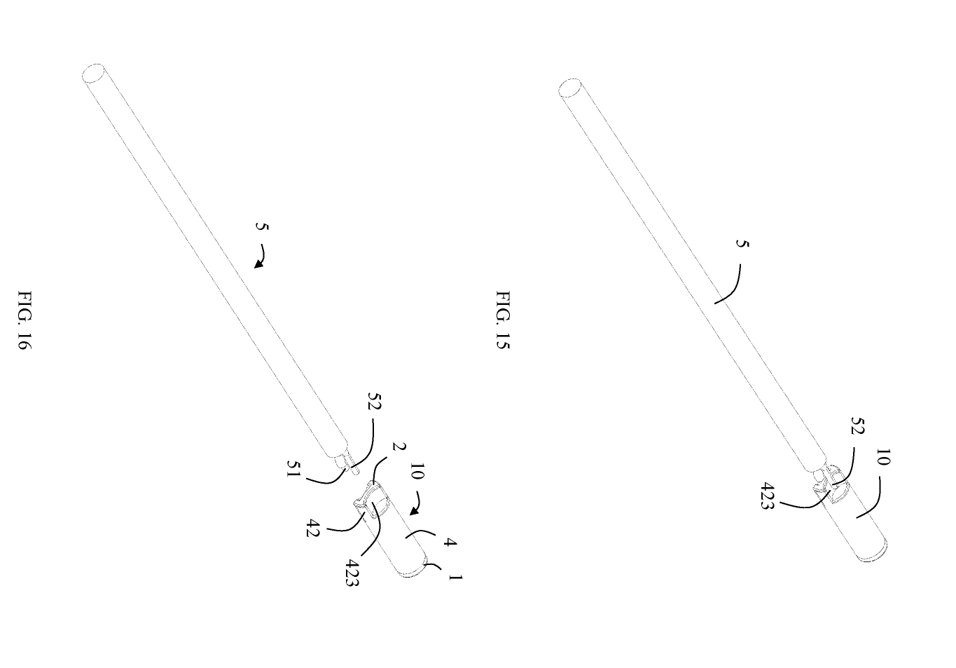

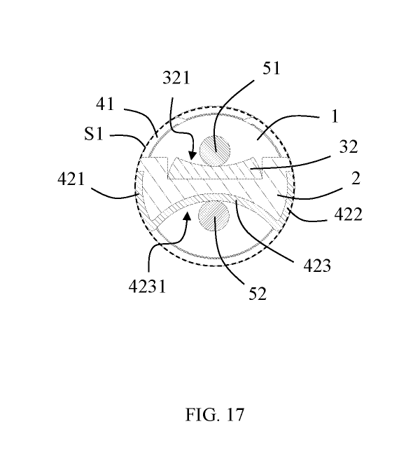

The cable 5 includes a first polarity wire (for example, a positive electrode wire) and a second polarity wire (for example, a negative electrode wire). In the illustrated embodiment of the present disclosure, the first polarity wire is a power wire 51. The second polarity wire is a grounding wire 52. The power wire 51 is at least partially located in the first groove 321. The grounding wire 52 is at least partially located in the second groove 4231. The power wire 51 is electrically connected to the first mounting portion 32. The grounding wire 52 is electrically connected to the second mounting portion 423. Specifically, the first arc-shaped mounting surface 322 is connected to the power wire 51. The second arc-shaped mounting surface 4232 is connected to the grounding wire 52. For example, the power wire 51 is fixed to the first mounting portion 32 by soldering or welding. The grounding wire 52 is fixed to the second mounting portion 423 by soldering or welding. Specifically, referring to FIGS. 15 and FIG. 16, in the illustrated embodiment of the present disclosure, the grounding wire 52 after fixation is located within the second mounting portion 423. That is, the grounding wire 52 after fixation does not exceed beyond a range of the second mounting portion 423. Referring to FIGS. 14 and FIG. 17, in the illustrated embodiment of the present disclosure, the sleeve portion 41 has a surrounding area S1 extending along a circumferential direction of the sleeve portion 41 (as shown in the dotted line in FIG. 17). The power wire 51 and the grounding wire 52 are both located within a range of surrounding area S1. Specifically, the sleeve portion 41 is cylindrical, and the surrounding area S1 is circular. Observing along an axial direction of the sleeve portion 41, the power wire 51 and the grounding wire 52 are both located within the range of the surrounding area S1. Referring to FIGS. 1-FIG.12, the over-molding housing 6 is molded on the terminal module 10 and the cable 5. The over-molding housing 6 is made of an insulating material. In the illustrated embodiment of the present disclosure, the over-molding housing 6 includes a first molding housing 61 and a second molding housing 62.

In the illustrated embodiment of the present disclosure, the second molding housing 62 includes a first convex ring portion 621 and a second convex ring portion 622 disposed opposite to the first convex ring portion 621. The first molding housing 61 includes a third convex ring portion 611 and a fourth convex ring portion 612 disposed opposite to the third convex ring portion 611. In the illustrated embodiment of the present disclosure, the third convex ring portion 611 is molded on the first convex ring portion 621, and the fourth convex ring portion 612 is molded on the second convex ring portion 622.

Compared with the prior art, the cable connector 100 of the present disclosure includes the mounting base 2. The first mounting portion 32 and the second mounting portion 423 are located on opposite sides of the mounting base 2, respectively. The power wire 51 is electrically connected to the first mounting portion 32. The grounding wire 52 is electrically connected to the second mounting portion 423. As a result, the cable connector 100 of the present disclosure arranges the first mounting portion 32 and the second mounting portion 423 in a region close to each other, thereby facilitating the saving of profile and facilitating miniaturization.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. A connector, comprising:
an insulating body comprising a main body portion;
a mounting base connected to the insulating body;
a conductive terminal disposed in the insulating body, the conductive terminal comprising a contact portion disposed in the main body portion and a first mounting portion disposed on the mounting base, the contact portion being configured to contact a mating conductive terminal;
a conductive shell at least partially enclosing the insulating body, the conductive shell comprising a second mounting portion disposed on the mounting base; and
a cable comprising a first polarity wire and a second polarity wire, the first polarity wire being electrically connected to the first mounting portion, and the second polarity wire being electrically connected to the second mounting portion;
wherein the first mounting portion and the second mounting portion are located on opposite sides of the mounting base.

2. The connector according to claim 1, wherein the first polarity wire is a power wire, and the second polarity wire is a grounding wire.

3. The connector according to claim 1, wherein the first mounting portion comprises a first arc-shaped mounting surface, the second mounting portion comprises a second arc-shaped mounting surface, and a recessed direction of the first arc-shaped mounting surface is opposite to a recessed direction of the second arc-shaped mounting surface.

4. The connector according to claim 3, wherein the first arc-shaped mounting surface is connected to the first polarity wire, and the second arc-shaped mounting surface is connected to the second polarity wire.

5. The connector according to claim 1, wherein the main body portion comprises a positioning groove, and the conductive shell comprises a positioning protrusion engaged in the positioning groove.

6. The connector according to claim 1, wherein the insulating body comprises a head portion connected to the main body portion; the head portion and the mounting base are located at two ends of the main body portion, respectively; the insulating body comprises a positioning surface at a junction between the head portion and the main body portion; and the conductive shell comprises a sleeve portion enclosing the main body portion, and the sleeve portion has an end face abutting against the positioning surface.

7. The connector according to claim 6, wherein the head portion comprises a first outer cylindrical surface, the sleeve portion comprises a second outer cylindrical surface, and the first outer cylindrical surface is flush with the second outer cylindrical surface.

8. The connector according to claim 1, wherein the mounting base and the insulating body are separately provided and fixed together.

9. The connector according to claim 8, wherein the mounting base and the insulating body comprise a post and a position hole; and the post is inserted in the position hole.

10. The connector according to claim 1, wherein the mounting base comprises a first mounting groove and a second mounting groove disposed opposite to the first mounting groove; the first mounting portion is disposed in the first mounting groove; and the second mounting portion is disposed in the second mounting groove.

11. The connector according to claim 1, wherein the mounting base comprises a limiting rib away from the main body portion; the conductive shell comprises a first extension side wall and a second extension side wall; the first extension side wall has a first end face; the second extension side wall has a second end face; and both the first end face and the second end face abut against an inner side of the limiting rib.

12. The connector according to claim 11, wherein the second mounting portion is connected between the first extension side wall and the second extension side wall.

13. The connector according to claim 1, wherein the mounting base is an insulating mounting base.

14. The connector according to claim 1, wherein the contact portion defines a receiving cavity configured to accommodate the mating conductive terminal.

15. The connector according to claim 1, wherein the first mounting portion defines a first groove, and the first polarity wire is at least partially received in the first groove;
the second mounting portion defines a second groove, and the second polarity wire is at least partially received in the second groove.

16. The connector according to claim 15, wherein the second polarity wire is fixed to the second mounting portion by soldering or welding; and the second polarity wire is located within the second mounting portion after fixation.

17. The connector according to claim 1, wherein the conductive shell comprises a sleeve portion enclosing the main body portion; the sleeve portion has a circumferential surrounding area extending along a periphery thereof; both the first polarity wire and the second polarity wire are located within the circumferential surrounding area.

18. A connector, comprising:
an insulating body comprising a main body portion;
a mounting base connected to the insulating body;
a conductive terminal coupled with the insulating body, the conductive terminal comprising a contact portion disposed in the main body portion and a first mounting portion attached to the mounting base from a first side;
a conductive shell at least partially sleeved on the insulating body, the conductive shell comprising a second mounting portion attached to the mounting base from a second side, the first side being disposed opposite to the second side; and
a cable comprising a power wire and a grounding wire, the power wire being electrically connected to the first mounting portion, and the grounding wire being electrically connected to the second mounting portion;
wherein the first mounting portion and the second mounting portion are located on opposite sides of the mounting base.

19. The connector according to claim 18, wherein the first mounting portion comprises a first arc-shaped mounting surface, the second mounting portion comprises a second arc-shaped mounting surface, and a recessed direction of the first arc-shaped mounting surface is opposite to a recessed direction of the second arc-shaped mounting surface.

20. The connector according to claim 19, wherein the first arc-shaped mounting surface is connected to the power wire by soldering or welding, and the second arc-shaped mounting surface is connected to the grounding wire by soldering or welding.
